(19) United States
(12) Patent Application Publication
(10) Pub. No.: US 2007/0170114 A1
(43) Pub. Date: Jul. 26, 2007

(54) Method and biological product for the residential and commercial aquatic environment

(76) Inventors: Michael Richter, Oceanside, NY (US); Douglas A. Dent, New Hope, PA (US)

Correspondence Address: Ecological Laboratories, Inc., 215 N Main Street, Freeport, NY, 11520, US

(21) Appl. No.: 11/704,498

(22) Filed: Feb. 12, 2007

Related U.S. Application Data
(63) Continuation-in-part of application No. 11/337,908, filed on Jan. 24, 2006, now abandoned.

(51) Int. Cl. C02F 3/00

(52) U.S. Cl. 210/610; 210/615

(57) ABSTRACT

A method and product for improving the biological attachment and bio-film formation on filter media for use in treating an aquarium, pond and body of water having impurities therein. The product consists of a biological formulation in gel form designed for a slow release of microorganisms to the receiving media. The product is in a liquid gel form to colonize filter media which are contained within a biological filter.

This application is a Continuation In Part CIP of pending application No. Ser. 11/337,908

### FIELD OF THE INVENTION

The invention is directed to direct fermentation bio-technologies for developing, formulating microbial technologies, and products designed for the residential and commercial aquatic environment, such as the pond and aquarium segments and application for water clarification and purification via enhanced biological filtration systems performance termed bio-filters.

### BACKGROUND OF THE INVENTION

Biological filters are an essential method employed in pond and aquarium design to increase the surface area essential to the biological oxidation and removal of the high loading of organic waste matter resulting from feeding and the waste matter produced by marine life within the aquatic environment. In the bio-filters microorganisms grow, attach to the surface media within the bio-filter and then form bio-films on the media within biological filters to accomplish organic removal of waste organic matter. This process within the filtration system is necessary and critical to pond and aquarium systems to effectively provide the rate of biological oxidation within the filtration system to protect marine life from the toxic effects of high organic matter, ammonia and the by-pruducts of nitrification. The inventive discovery is designed to specifically speed the microbial attachment to filter media and the development of essential bio-films within the bio-filter system to enhance the biological removal of waste matter form the aquatic environment within biological filters. This is accomplished by increasing the rate of microbial attachment to the filter media, a more rapid biofilm development and improved bio film performance, to promote a cleaner aquatic environment and to support a healthy marine life.

The need for a more rapid biological removal process in aquarium and pond filtration environments is due to a low level of microbial activity in a new system start-up, or following necessary periodic filter cleaning. During the start-up period or following filter cleaning, the organic loading from residual fish fold or fish waste within the aquatic environment can exceed the aquarium or pond system's biological removal process. The high rate of loading of waste organic matter and low rate of biological removal results in high levels of waste organic matter within the aquatic feature, ammonia production, nitrite and nitrate that can result in a toxic environment, followed by stress or death to marine life.

The inventive concept is directed to a novel viscous microbial formulation designed to provide a rapid recovery of bio-filter filter systems by seeding the biological filters and filter pads in the flowing water to the filter inlet with microorganisms to enhance, improve and speed the attachment of microorganisms to a filter media contained within biological filtration systems, termed bio-filters, followed by a rapid development of essential bio-films on the filter media.

There are currently biological products (that contain microorganisms) that are designed for use in the pond waters to assist and speed the necessary biological oxidation process responsible for the removal of waste organic matter from pond and aquarium water. Biological oxidation of waste organic matter is accomplished by microorganisms and by selecting microbe and technologies to enhance water quality by increasing the rate of biological oxidation of waste organic matter to assure an environment that will support aquatic life forms. Pond filters, termed bio-filters, represent a significant function in organic removal and the discovery is designed to speed the microbial attachment to filter media and the development of essential bio-films for rapid recovery and improved filter performance.

Water quality is effected by the increased organic loading associated with enclosed aquatic features that contain a large number of marine life, fish for example, as these factors contribute to water pollution via the high levels of organic waste matter. Water pollution comes from a variety of marine species confined in a specific water volume (closed system); as well as the continued growth of the fish, the addition of their off-springs (all aquatic species), their waste, excessive feeding of the fish and air borne pollutants. These factors all contribute to a rapid water pollution as the organic loading to the confined body of water is greater than the natural biological oxidation of waste organic matter by the indigenous microorganism. These factors lead to reduced water quality and the potential loss of aquatic life from pollution During start-up and followed by filter cleaning, the function of bio-filters is critical to marine life.

### BRIEF DESCRIPTION OF THE INVENTION

The inventive concept is designed to provide a product and method for bio-film development in biological filters. This is achieved by speeding and enhancing the attachment of microorganisms to the biological pond filter media via a slow continued release of microorganism form gel matrices on the receiving filter media. This concept will speed the rate of the biological attachment and bio-film development on the filter media, following filter cleaning, pond down time, and the same time of pond and filter start -up, and for newly installed biological filtration systems. Bio-film attachment to filter surface media is essential to the functionality of pond biological filtration systems for organic removal, nitrification (ammonia removal) and de-nitrification.

The viscous gel formulation is formulated and derived from a liquid culture consortium in combination with zantum gum, a viscosity builder. The microbes used are a series of vegetative or spore forming cultures. The spore forming formulation requires the use of inhibitory constituents such as proxel, IPA, EDTA and Methyl anthranilate in the range of 750/ppm to 2000/ppm to stabilize the formulation.

The viscous bio formulation containing vegetative microorganisms feature an inhibitory element composed of a level of a biologically produced hydrogen sulfide gas for stabilization at 600/ppm to 800/ppm.

The percentage of zantum gum is based on the viscosity desired and ranges from 0.5% to 1% of the formulation, with a viscosity greater than 1,500 to 3.000 centistroke via a viscometer meter. The gel forming material is added following the culture formulation and blending using high sheer blending until the desired viscosity is obtained and a stable gel condition is formed. The period for blending is from 15 to 30 minutes.

This microbial development provides for a slow but continued release of microorganisms from the system's pre filter pad at the filter's influence. The biological invention features a viscous liquid microbial formulation designed for an application to filter pads placed at the influent section of filtration systems. The inventive concept provides for a slow release of microorganisms over a period of time to the biological filter influent water for a more effective method of seeding filter media.

The slow continued release of microorganisms from the bio gel to the bio-filter media allows for an improvement in the initial charge attachment of microorganisms to the filter media and essential bio-film formation.

### DESCRIPTION OF BIO-FILMS

Bio-films consist of two major components (1) microorganisms that are embedded in (2) a matrix of extra cellular polymer substances (ESP) of microbial origin. such bio-films result from the initial absorption of microorganisms to a solid substrata followed by growth of the microorganisms, ESP production, and the capture or entrapment of other microbial cells from the aqueous phase.

In order to emphasize the importance of bio-films in ponds and aquarium filter waste water processes it, should be noted that the bio-films may contain as many suspended 10/16 cells/m³ (10-13 cells/liter), a cell concentration considerably higher than suspended cultures in water. This high rate biological concentration, oxidation reaction, combined with surface area increases organic removal effect significantly. This invention is designed to improve bio-film development and performance by providing an effective method to seed biological filter media during pond start-up, following filter cleaning and after shock kills.

Bio-film Development via microbial cells and division. (10) transport of cell to the media (susbstratum), (2) absorption of cells to the media, (3) growth and other metabolic processes within the bio-film (EPS production). The bacteria cells released from the discovery (gel) application to the filter media will fist form initial charge attachment to the media, grow and cell divide, new microbes will form followed by the development of gel materics (EPS) and formation of a bio-film. The bio-film and combined microorganisms will absorb and break down organic matter while improving the performance of the media specific to a bio-film formation and overall removal of waste organic matter.

The inoculated media such as filter pads and other related materials will increase the rate of bio-film development and overall microbial functions specific to achieving rapid biological oxidation of organic matter within bio-filters and other related biological water clarification systems and equipment. As mentioned above, the inventive concept is based on a slow release of microorganisms from a liquid gel bio-formulation to colonize a wide range of all types of filter media to speed bacteria attachment and bio-film development via waste degrading heterotrophic microorganisms, to include photosynthetic heterotrophic microorganisms. Examples of such filter media are shown below”

### Filter Media

Microorganisms attach to grow and develop bio-films on all types of filter media including the following media; pin balls, media bags, ceramic rings, mini pads, zeollite, activated carbon, carbon pellets, zeolite chips and other filter media of all types.

### Bacteria

Bacteria are a substance of numerous microscopic, spherical rod-shaped or spiral organisms, various species of which are concerned in fermentation, biological oxidation of organic matter removal and purification. The biological purification of aquarium and pond water bodies by enhancing filter performance is the inventive concept of this specification. Bacteria are key catalysts in the inventive process.

### Bacteria—Spore Forming

As above to include such strain as:
1. Bacillus lichenformis
2. Bacillus megaterium
3. Bacillus polymyxa
4. Bacillus cerculans
5. Bacillus subtillis
6. Paenibacillus polymyxa
7. Bacillus polymyxa

### Bacteria—Vegetative

8. Rodopseudomonas
9. Rhodospirillum
10. Thiobacillus novellas
11. Thiobacillus thiooxidans
12. Thiobacillus denitrificans
13. Pseudonomas flourescens
14. Alealigenes denitrificans
15. Flavobactrium aquatile
16. Flavobactrium oceanosedimentum
17. Nitrobacter winogradsky
18. Nitrosonomas europaea
19. Serratia liquifaciens
   The above gel formulations and cultures may be used to inoculate various filter media described above. The benefits of a slow release of microorganisms from a gel formulation as recited above is that it speeds filter media bio-film development which is essential to a biological oxidation of waste organic matter from aquatic features, aquariums, ponds and waters using biological filters. There is no reason to wait for long bio-film developments to occur.

### Method of Use of Filter Media Gel

The slow release of microorganisms from the gel to the filter media will first form an attachment via charge followed by bio-film formation on the media preferably within biological filters where there is a flow or circulation of water that will provide organic matter for bio-film removal and biological oxidation (organic removal). The biological gel can be applied to all pre filter pads, filter inlets, and in all biological filters, pressurized filters, filter falls, and skimmer baskets. The gel discovery helps speed microbial attachment to the media, microbial growth and bio-film development in an easy to use application method to the filter's inlet.

What is claimed is:

1. A method of treating a body of water having impurities therein including the step of using a filter media, said filter media, inoculating said filter media a with viscous gel having microorganism bacteria therein to speed a bio-film development, said body of water is an aquatic environment including ponds, lagoons and aquariums, placing said viscous gel filter media at an inlet of said body of water having a water flow therein and releasing said microorganisms by having contact with said body of water to thereby increase the removal of the organic waste from said body of water.

2. The method of claim 1, wherein said filter media is contained in a preapckged bag.

3. The method of claim 1, wherein said filter media is a pad system.

4. The method of claim 1, wherein said filter media is selected from the group consisting of biological pin balls, biological ceramic rings, mini pads, Zeolite chips, carbon pellets, and a combination of Zeolite chips and carbon pellets.
